(19) United States
(12) Patent Application Publication
(10) Pub. No.: US 2015/0287988 A1
(43) Pub. Date: Oct. 8, 2015

(54) RECHARGEABLE BATTERY BASED ON REVERSIBLE MANGANESE OXIDATION AND REDUCTION REACTION ON CARBON/MANGANESE DIOXIDE COMPOSITES

(71) Applicant: Graduate School at Shenzhen, Tsinghua University, Shenzhen (CN)

(72) Inventors: Chengjun XU, Shenzhen (CN); Yanyi CHEN, Shenzhen (CN); Shan SHI, Shenzhen (CN); Feiyu KANG, Shenzhen (CN)

(21) Appl. No.: 14/322,519

(22) Filed: Jul. 2, 2014

Related U.S. Application Data
(63) Continuation of application No. PCT/CN2014/074751, filed on Apr. 3, 2014.

(51) Int. Cl. H01M 4/42; H01M 4/62; H01M 4/50; H01M 10/36; H01M 4/583

(52) U.S. Cl. CPC H01M 4/42; H01M 10/36; H01M 4/583; H01M 4/50; H01M 4/624; H01M 4/622; H01M 4/623; H01M 2300/0002; H01M 2004/027

(57) ABSTRACT

The present invitation discloses a high capacity rechargeable battery, which comprises a carbon/manganese dioxide composite cathode; a zinc anode separated from cathode; an aqueous electrolyte contains zinc (Zn²⁺) and manganese (Mn²⁺) ions. The present invitation utilizes the oxidation/reduction of Mn²⁺ ions on carbon/manganese dioxide composite to improve the capacity and the cycle life of the battery.

### BACKGROUND

This invention relates to rechargeable zinc ion batteries with high capacity and long cycle life.

The US patent (U.S. Pat. No. 8,663,844 B2) invented a so-called zinc ion battery, which uses α-MnO₂ as cathode, zinc as anode and ZnSO₄ aqueous solution as the electrolyte. The battery chemistry of zinc ion battery is written as:

Cathodic reaction: xZn²⁺+2Xe⁻+MnO₂ [symbol] ZnₓMnO₂ (1)

Anodic reaction: Zn [symbol] Zn²⁺+2e⁻ (2)

The advantage of zinc ion battery is ecofriendly, safety and low cost. However, the disadvantage of zinc ion battery is the low capacity of the battery. The capacity of MnO₂ is as low as 200 mAh g⁻¹, which preclude it from various applications for example electric vehicles. In addition, the cycle life of this battery is short. Therefore, it is necessary to discover new cathode active materials with a high capacity to further improve the energy density of zinc ion battery.

### SUMMARY OF THE INVITATION

The purpose of this patent is to invent a new battery with high capacity and long cycle life.

Due to the energy crisis, our society requires rechargeable batteries with high capacity and long cycle life to power the portable electronics for further long time, to drive the electric vehicles rivaling cars powered by the combustion engine, and to store electricity generated by renewable sources.

Carbon supporting manganese dioxide, which is simply denoted as carbon/MnO₂, is worldwide interesting electrode material for the batteries or supercapcitors. The design of manganese dioxide deposited on the carbon support increases the conductivity of MnO₂ and improves the contact between MnO₂ and the electrolyte. As a result, the carbon/MnO₂ composite can obtain a better electrochemical behavior than pure MnO₂.

In addition, we firstly found in this application that there is the reversible manganese oxidation/reduction of Mn²⁺ ions on the carbon/MnO₂ composites, which is simply written as:

Mn²++2H₂O [symbol] MnO₂+4H⁺+2e⁻ (3)

The cyclic voltammetry (CV) as shown in FIG. 1 clearly shows the reversible manganese oxidation/reduction reaction on the carbon/MnO₂ composites. The manganese oxidation reaction from soluble Mn²⁺ ions to MnO₂ deposits occurs at 1.58 vs. Zn²⁺/Zn and then extraction of Zn²⁺ ions from MnO₂ occurs at 1.63 V vs. Zn²⁺/Zn, while insertion of Zn²⁺ ions into MnO₂ and the manganese reduction reaction from MnO₂ to soluble Mn²⁺ ions occur at 1.35 V and 1.20 V vs. Zn²⁺/Zn, respectively.

There are synergistic reactions between manganese oxidation/reduction reaction (equation 1) and storage/release of Zn²⁺ ions into/from MnO₂ (equation 3). The reversibility of manganese oxidation/reduction reaction can be improved to 100% by adding Mn⁴⁺ source (MnO₂) in carbon/MnO₂ composites. Meanwhile, MnO₂ can reversibly store/release Zn²⁺ ions during discharge/charge as shown in equation 1. Therefore, this invention utilizes the oxidation/reduction of Mn²⁺ ions on carbon/manganese dioxide composites to improve the capacity and the cycle life of the battery.

The rechargeable zinc ion battery comprise of a cathode composing of the active composite of carbon supporting manganese dioxide; a zinc anode; a separator for separating said cathode from said anode; and an aqueous electrolyte containing zinc ions (Zn²⁺) and manganese (Mn²⁺) ions.

The said carbon supporting manganese dioxide is that the manganese dioxide is deposited on the carbon material, where carbon is as support for manganese dioxide.

The said carbon material can be any shape of carbon element, for example, fullerene, carbon nanotube, graphene, carbon fiber, carbon foam. The said carbon material can be the composite of over two different carbon materials.

The said manganese dioxide represents a general class of tunnel materials. The basic structural unit of manganese dioxide is MnO₆ octahedron. MnO₆ octahedra can share vertices and edges to form endless chains of MnO₆ octahedral subunits, which can in turn be linked to neighboring octahedral chains by sharing corners oredges. The piling up of MnO₆ units enables the building of one dimension (1D), two dimension (2D) or three dimension (3D) tunnels of manganese dioxide. 1D manganese dioxide is known as alpha type manganese dioxide (α-MnO₂), beta type manganese dioxide (β-MnO₂), gamma type manganese dioxide (γ-MnO₂), etc. 2D manganese dioxide is known as birnessite δ-MnO₂. 2D manganese dioxide is known as λ-MnO₂. In addition, manganese dioxide often contains foreign cations, physisorbed and structural water moleculars in its tunnel. There are many types of manganese dioxide containing various univalent and bivalent cations in its tunnels. For example, α-MnO₂ groups with 1D structure possess a large open tunnel structure including holladite group (Mg, Ca, Ba, K) Mn₈O₁₆, psilomelane group (Ca, Ba, K) Mn₅O₁₀.H₂O and todorokite group (Mn, Ca, Mg) Mn₃O₇.H₂O. 2D birnessite group minerals include chalcophanite ZnMn₃O₇.3H₂O, buserite (Ca, Na) Mn₇O₁₄.3H₂O and ranceite (Ca, Mn) Mn₄O₉.3H₂O. And λ-MnO₂ groups with 3D tunnel include hetaerolite ZnMn₂O₄, hydroehetaerolite Zn₂Mn₄O₁₈.H₂O etc.

The said carbon material can be composed of one uniform carbon materials for example carbon nanotube fabric, carbon fiber fabric, etc.

The said zinc anode is in any shapes of pure zinc or zinc alloy, such as the foil, film, plat, grid, pillar, etc.

The said zinc anode can also be a compressed mixture of pure zinc and/or zinc alloy particles, electrically conductive particles and a binder, and this compressed mixture is normally attached by the used binder on a current collector.

The said binder is selected from the group consisting of natural and synthetic rubbers, polysulfone, acrylic polymers, epoxy resins, polystyrene and polytetrafluoroethylene.

The said aqueous electrolyte comprises a solvent and a solute. The said solvent is water. The solute is the mixture of zinc slats and manganese salts. The said zinc slat is ZnSO₄, Zn(NO₃)₂, or ZnCl₂, etc. and the said manganese slat is MnSO₄, Mn(NO₃)₂, or MnCl₂, etc.

The said separator is a thin layer of a suitable material, which can physically separate the said anode from the cathode. This separator is nonoxidizable and stable in the cell environment.

The said rechargeable zinc ion battery can be configured as “button” cell, cylindrical cell or rectangular cell, etc.

In addition, additives with specific function can be added in the anode, cathode or electrolyte to improve the performance of the batteries.

### BRIEF DESCRIPTION OF THE DRAWINGS

FIG. 1 Cyclic voltammetry of the reversible manganese oxidation/reduction reaction on the carbon/MnO₂ composites.

FIG. 2 The discharge and charge curves of Cell 1 at a current density of 0.1 A g⁻¹ (based on the positive active mass).

FIG. 3 The discharge and charge curves of Cell 2 at a current density of 0.1 A g⁻¹ (based on the positive active mass).

FIG. 4 The discharge and charge curves of Cell 3 at a current density of 0.1 A g⁻¹ (based on the positive active mass).

FIG. 5 The discharge and charge curves of Cell 4 at a current density of 0.5 A g⁻¹ (based on the positive active mass).

### DETAILED DESCRIPTION OF THE PREFERRED EMBODIMENTS

Compositions of matter, articles of manufacture and methods for manufacture are set forth herein for preparation of carbon materials, battery electrodes, and the rechargeable battery.

The synthesis of graphene/MnO₂ composites is shown in below. A 0.1 mol/L KMnO₄ aqueous solution was prepared by dissolving KMnO₄ (AR, 99%) in deionized water. An AOT/isooctane solution was prepared by adding 66.6 g surfactant of high purity sodium bis(2-ethylhexyl) sulfosuccinate (Aerosol-OT, AOT) to 1500 mL isooctane and stirring them well. 81 mL of 0.1 mol/L KMnO4 aqueous solution was then added in the AOT/isooctane solution, and 0.1244 g graphene was added into this mixture solution. Then it was ultrasound for 30 min to obtain a dark brown precipitate. The deposit was separated, washed with deionized water and ethanol several times, and dried at 90° for 12 h.

The synthesis of MnO₂ is shown in below. A 0.1 mol/L KMnO₄ aqueous solution was prepared by dissolving KMnO₄ (AR, 99%) in deionized water. An AOT/isooctane solution was prepared by adding 66.6 g surfactant of high purity sodium bis(2-ethylhexyl) sulfosuccinate (Aerosol-OT, AOT) to 1500 mL isooctane and stirring them well. 81 mL of 0.1 mol/L KMnO4 aqueous solution was then added in the AOT/isooctane solution, and then ultrasound for 30 min to obtain a dark brown precipitate. The nano-sheet MnO₂ was separated, washed with deionized water and ethanol several times, and dried at 90° C. for 12 h.

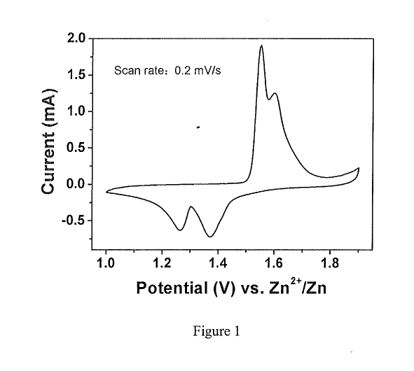

The electrode composing of graphene/MnO₂ composites is fabricated as following. Graphene/MnO₂ composites (70%), carbon black (20%) and LA133 binder (10%) were stirred 30 min to obtain the slurry. The slurry was coated on one side of the stainless steel foil current collector, and then dried at 90° C. for 10 h under vacuum. The electrode then was cut into a round shape with a diameter of 1.5 cm. This is graphene/MnO₂ cathode. The cyclic voltammetry of graphene/MnO₂ cathode in 1 molar per liter (M) ZnSO₄ and 2 M MnSO₄ aqueous solution is shown in FIG. 1.

The MnO₂ cathode is fabricated as following. MnO₂ (70%), carbon black (20%) and LA133 binder (10%) were stirred 30 min to obtain the slurry. The slurry was coated on one side of the stainless steel foil current collector, and then dried at 90° C. for 10 h under vacuum. The electrode then was cut into a round shape with a diameter of 1.5 cm.

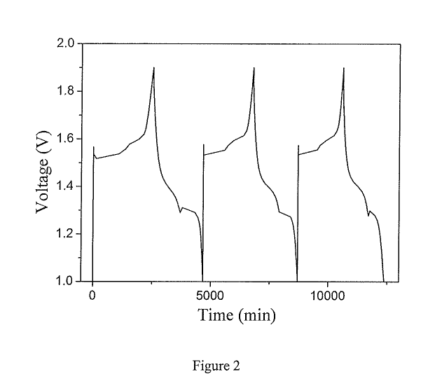

The battery test used the coin cell assembly consisting of graphene electrode as cathode and zinc film (20 μm in thickness) as anode. A glass paper was used as the separator. The electrolyte is 1 M ZnSO₄ and 2 M MnSO₄ aqueous solution. This cell was denoted as Cell 1. The discharge and charge curves of Cell 1 are shown in FIG. 2 at a current density of 0.1 A g⁻¹ (based on the positive active mass). The capacity of this battery is over 4200 mAh g⁻¹. During cycling the Coloumbic efficiency of such battery is close to 100%.

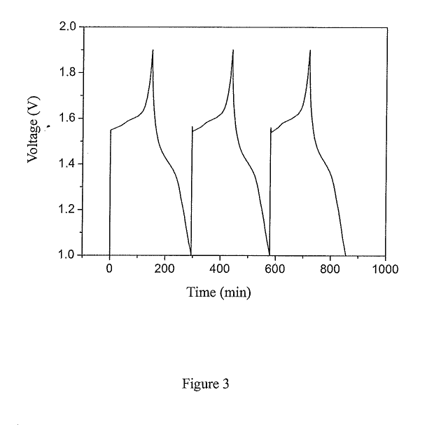

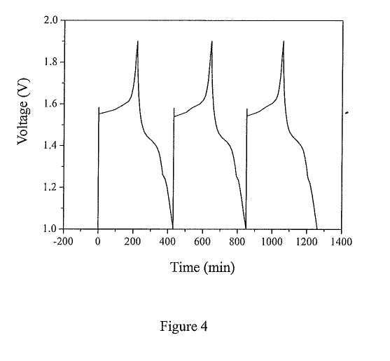

In order to demonstrate the effect of reversible manganese oxidation/reduction reaction on the carbon/MnO₂ composites, we assembled two other cells. The Cell 2 comprises of MnO₂ cathode, zinc film (20 μm in thickness) anode, and 1 M ZnSO₄ and 2 M MnSO₄ aqueous electrolyte. In addition, we assembled the Cell 3 without Mn²⁺ ions in the electrolyte. The Cell 3 comprises of graphene/MnO₂ cathode, zinc film (20 μm in thickness) anode, and 1 M ZnSO₄ aqueous electrolyte. It is shown that in comparison with Cell 1, Cell 2 uses MnO₂ instead of carbon/MnO₂ composites as the cathode, while Cell 3 uses the aqueous electrolyte without Mn²⁺ ions. The discharge and charge curves of Cell 2 and Cell 3 are shown in FIG. 3 and FIG. 4 at a current density of 0.1 A g⁻¹ (based on the positive active mass), respectively. The capacities of Cell 2 and Cell 3 are 200 and 260 mAh g⁻¹. It is shown from the capacities of Cell 1, Cell 2, and Cell 3 that the capacity of the zinc ion battery is improved by the reversible manganese oxidation/reduction reaction on the carbon/MnO₂ composites. In addition, the cycle lives of Cell 1, Cell 2, and Cell 3 are 1000, 150, and 200 cycles. The reversible manganese oxidation/reduction reaction on the carbon/MnO₂ composites increases the cycle life of the zinc ion battery.

The synthesis of carbon nanotube/MnO₂ composites is shown in below. A 0.1 mol/L KMnO₄ aqueous solution was prepared by dissolving KMnO₄ (AR, 99%) in deionized water. An AOT/isooctane solution was prepared by adding 66.6 g surfactant of high purity sodium bis(2-ethylhexyl) sulfosuccinate (Aerosol-OT, AOT) to 1500 mL isooctane and stirring them well. 81 mL of 0.1 mol/L KMnO₄ aqueous solution was then added in the AOT/isooctane solution, and 0.1244 g carbon nanotube was added into this mixture solution. Then it was ultrasound for 30 min to obtain a dark brown precipitate. The deposit was separated, washed with deionized water and ethanol several times, and dried at 90° C. for 12 h.

The electrode composing of carbon nanotube /MnO₂ composites is fabricated as following. Carbon nanotube /MnO₂ composites (70%), carbon black (20%) and LA133 binder (10%) were stirred 30 min to obtain the slurry. The slurry was coated on one side of the stainless steel foil current collector, and then dried at 90° C. for 10 h under vacuum. The electrode then was cut into a round shape with a diameter of 1.5 cm. This is carbon nanotube /MnO₂ cathode.

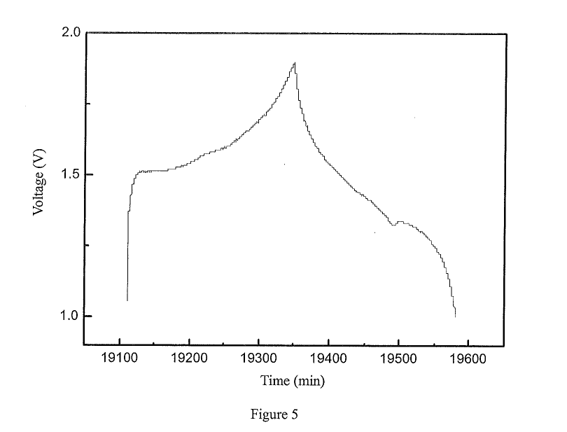

The battery test used the coin cell assembly consisting of carbon nanotube/MnO₂ electrode as cathode and zinc film (20 μm in thickness) as anode. A glass paper was used as the separator. The electrolyte is 1 M ZnSO₄ and 1 M MnSO₄ aqueous solution. This cell was denoted as Cell 4. The discharge and charge curves of Cell 4 are shown in FIG. 5 at a current density of 0.1 A g⁻¹ (based on the positive active mass). The capacity of this battery is over 1935 mAh g⁻¹. During cycling the coloumbic efficiency of such battery is close to 100%.

1. A rechargeable battery comprises of:
a cathode composing of carbon/manganese dioxide composite;
a zinc anode;
a separator for separating said cathode from said anode; and
an aqueous electrolyte containing zinc ions (Zn²⁺) and manganese (Mn²⁺) ions.

2. A rechargeable cell as defined in claim 1 wherein said carbon/manganese dioxide composite is that manganese dioxide is deposited on the carbon material, where carbon is as support material for manganese dioxide.

3. A rechargeable cell as defined in claim 1 wherein said carbon material is any shape of carbon element, for example, fullerene, carbon nanotube, graphene, carbon fiber, carbon foam or the composite of over two different carbon materials, etc.

4. A rechargeable cell as defined in claim 1 wherein said aqueous electrolyte composes of solvent and solute. The solute is the mixture of zinc slats and manganese salts. And the solvent is water.

5. A rechargeable cell as defined in claims 1 wherein said zinc slat is ZnSO₄, Zn(NO₃)₂, or ZnCl₂, etc. and said manganese slat is MnSO₄, Mn(NO₃)₂, or MnCl₂, etc.

6. A rechargeable cell as defined in claim 1 wherein said zinc anode is in any shapes of pure zinc or zinc alloys.

7. A rechargeable cell as defined in claim 1 wherein said zinc anode is composed of a compressed mixture of pure zinc and/or zinc alloy particles, electrically conductive particles and a binder.

8. A rechargeable cell as defined in claim 1 wherein said binder is selected from the groups consisting of natural and synthetic rubbers, polysulfone, acrylic polymers, epoxy resins, polystyrene and polytetrafluoroethylene.
